(19) United States
(12) Patent Application Publication
(10) Pub. No.: US 2009/0086352 A1
(43) Pub. Date: Apr. 2, 2009

(54) COLOR FILTER STRUCTURE AND METHOD OF MAKING THE SAME

(76) Inventors: Chun-Chieh Tsao, Hsin-Chu (TW); Hsiang-Lin Lin, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/135,215

(22) Filed: Jun. 9, 2008

(30) Foreign Application Priority Data
Oct. 1, 2007 (TW) 096136796

(51) Int. Cl. G02B 5/20; G02B 1/10

(52) U.S. Cl. 359/891; 347/105

(57) ABSTRACT

A color filter structure includes a plurality of hydrophobic light-shielding rows for a black matrix, and a color filter layer. Each hydrophobic light-shielding row has a plurality of light-shielding structures that have an individual space for accommodating the color filter layer and are arranged in series. In addition, each individual space of the light-shielding structures is closed, and this light-shielding structure involves at least one hydrophobic valve so as to provide a hydrophobic force.

### BACKGROUND OF THE INVENTION

1. Field of the Invention

The present invention relates to a color filter structure and method of making the same, and more particularly, to a color filter structure having a hydrophobic valve design, e.g. a hydrophobic channel or hydrophobic indentation able to prevent color mixing or uneven thickness, and a method of making the same.

2. Description of the Prior Art

Liquid crystal display (LCD) uses white light as a light source, and thus requires color filters to divide white light source into the three primary color light beams: red, green, and blue. The red, green, and blue light beams are mixed to become various colors that human eyes can perceive. Hence, the filtering effect of color filters is an important factor in color image performance. In addition, the cost of color filters is more expensive than other parts, and thus color filters are one of the most important components of an LCD.

In conventional methods, color filters are formed by coating photoresist materials and then exposing and developing the photoresist materials. First, color filter ink of a certain color e.g. red is coated on a substrate by spin coating (for example), and successive processes such as soft bake, exposure-and-development process, and hard bake are consecutively carried out to form the red color filter pattern. The above steps are repeated to form the green color filter pattern and blue color filter pattern. The utility rate of color filter ink according to the conventional method is very low, however. In the conventional process, approximately 90% of the color filter ink is thrown away in the process of spinning, and about 70% of the remaining color filter ink is resolved and removed in the development process. In addition, the conventional method requires repeating the coating process, the pre-bake process, and the exposure-and-development process, and thus the complexity and cost increase.

Accordingly, inkjet print technology is used to improve the disadvantage of the conventional spinning coating method. Refer to FIGS. 1-2. FIGS. 1-2 are schematic diagrams illustrating a conventional inkjet printing process. As shown in FIG. 1, a glass substrate 10 is provided, and a plurality of black matrix (BM) patterns 12 is formed on the glass substrate 10. The BM patterns 12 define a plurality of closed spaces 14 (e.g. the closed spaces 14 are arranged in an n×m matrix, where “n” and “m” are integrals) that do not communicate with one another. The closed spaces 14 are used to accommodate color filter ink. As shown in FIG. 2, an inkjet print head of an inkjet print device (not shown) is used to spray color filter ink on the glass substrate 10. Taking the fabrication steps of color filters arranged in stripes as an example, a primary color ink (e.g. red ink 16R) is consecutively sprayed in the closed spaces 14 positioned in 3n-2 columns of the BM patterns 12. Then, the other two primary color inks (e.g. green ink 16G and blue ink 16B) are respectively sprayed in the closed spaces 14 positioned in 3n-1 columns and 3n columns of the BM patterns 12. The glass substrate 10 is then heated to remove excessive solvent so that the red ink 16R, green ink 16G, and blue ink 16B are hardened to form color filters.

The inkjet print method is more efficient and cheap compared to the photolithographic method; however, the inkjet print method suffers from an inevitable variation in spray coverage after frequent use. This means the quantity of ink may be different in each of the spaces, which makes the successively formed color filters have different thicknesses. The uneven thickness of color filters will affect the image display effect. Furthermore, if the color ink is insufficient (normally referred to as unfilled pixel), the filtering effect of the color filter will be poor, thereby generating a white area due to the light leakage. If the color ink overflows, not only will the filtering effect be influenced but color mixing may also occur. If the color ink overflow occurs between color filters of the same color, the image performance may be acceptable. If the color ink overflow occurs between color filters of different colors, serious color distortion problem will appear due to color ink mixing.

### SUMMARY OF THE INVENTION

It is therefore a primary objective of the present invention to provide a color filter structure and method for making the same to overcome the problems of poor image display effect, white area, and color distortion of conventional color filters.

According to the present invention, a color filter structure is provided. The color filter structure of the present invention has a transparent substrate, a plurality of light-shielding rows, and a color filter layer. The transparent substrate has a surface. The light-shielding rows are hydrophobic and are disposed on the surface of the transparent substrate for defining a plurality of sub-pixels. Each light-shielding row has a plurality of light-shielding structures arranged in series along a first direction. Each of the light-shielding structures has a thickness and forms an individual space. Each of the light-shielding structures has at least one hydrophobic channel, so that the adjacent individual spaces arranged in the same light-shielding row communicate with one other. The color filter layer is disposed inside the individual spaces of the light-shielding structures.

According to the present invention, a color filter structure is disclosed. The color filter structure includes a transparent substrate, a plurality of light-shielding rows, and a color filter layer. The transparent substrate has a surface, and the light-shielding rows are hydrophobic and are disposed on the surface of the transparent substrate for defining a plurality of sub-pixels. Each of the light-shielding rows has a plurality of light-shielding structures arranged in series along a first direction. Each of the light-shielding structures with a thickness comprises an individual space and at least one hydrophobic indentation. Each of the individual spaces with the hydrophobic indentation is a closed space and the adjacent individual spaces do not communicate with one another. The color filter layer is disposed inside the individual spaces of the light-shielding structures.

According to the present invention, another color filter is disclosed. The color filter has a transparent substrate, a plurality of light-shielding arrays, and a color filter layer. The transparent substrate has a surface, and the light-shielding arrays are hydrophobic and disposed on the surface of the substrate to define a plurality of sub-pixels. Each of the light-shielding arrays includes a plurality of light-shielding structures arranged in series along a first direction. Each of the light-shielding structures has a thickness and forms an individual space. Each of the light-shielding structures has at least one hydrophobic channel for communication between the adjacent individual spaces in the same light-shielding row. The color filter layer is disposed inside the individual spaces of the light-shielding structures.

According to the present invention, a method of making a color filter structure is provided. The method includes the following steps of: providing a transparent substrate; forming a plurality of light-shielding rows on a surface of the transparent substrate, wherein each light-shielding row comprises a plurality of light-shielding structures, each light-shielding structure with a thickness has an individual space with at least one gap (a valve, an indentation, or a channel); performing a hydrophobic treatment upon the light-shielding rows to make each light-shielding structure hydrophobic and thereby form at least one hydrophobic valve from the at least one gap; and performing an inkjet printing process to inject color filter ink into each of the individual spaces, wherein a hydrophobic force resulted from each hydrophobic valve and a hydrostatic force resulted from the gravity of the color filter ink in each of the individual spaces reaches static balance, such that the color filter ink in the individual spaces of each light-shielding row is of the same height.

The method of the present invention prevents color filters from uneven thickness and color mixing during the inkjet printing process, thereby improving the image display effect, the reliability and product yield of the color filters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 are schematic diagrams illustrating a conventional inkjet printing process.

FIG. 3-5 are schematic diagrams illustrating the mechanism of adjusting the volume of the color filter ink in an individual space.

FIG. 6 and FIG. 7 are schematic diagrams illustrating a color filter structure according to another preferred embodiment of the present invention.

FIG. 8 is a top-view schematic diagram illustrating the light-shielding rows of the color filter structure according to a preferred embodiment of the present invention.

FIG. 9 is a top-view schematic diagram illustrating a light-shielding row of a color filter structure according to another preferred embodiment of the present invention.

FIG. 10 and FIG. 11 are schematic diagrams illustrating a color filter structure according to another preferred embodiment of the present invention.

FIG. 12 is a top-view schematic diagram illustrating a light-shielding row of a color filter structure according to a preferred embodiment of the present invention.

FIG. 13 is a flow chart showing a method of making the color filter structure of the present invention.

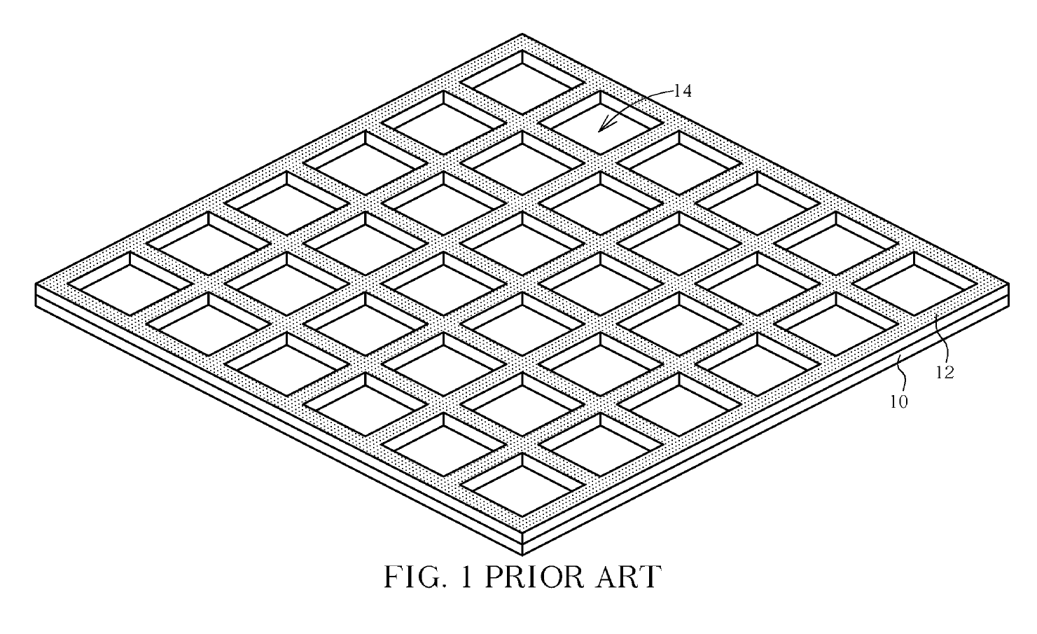

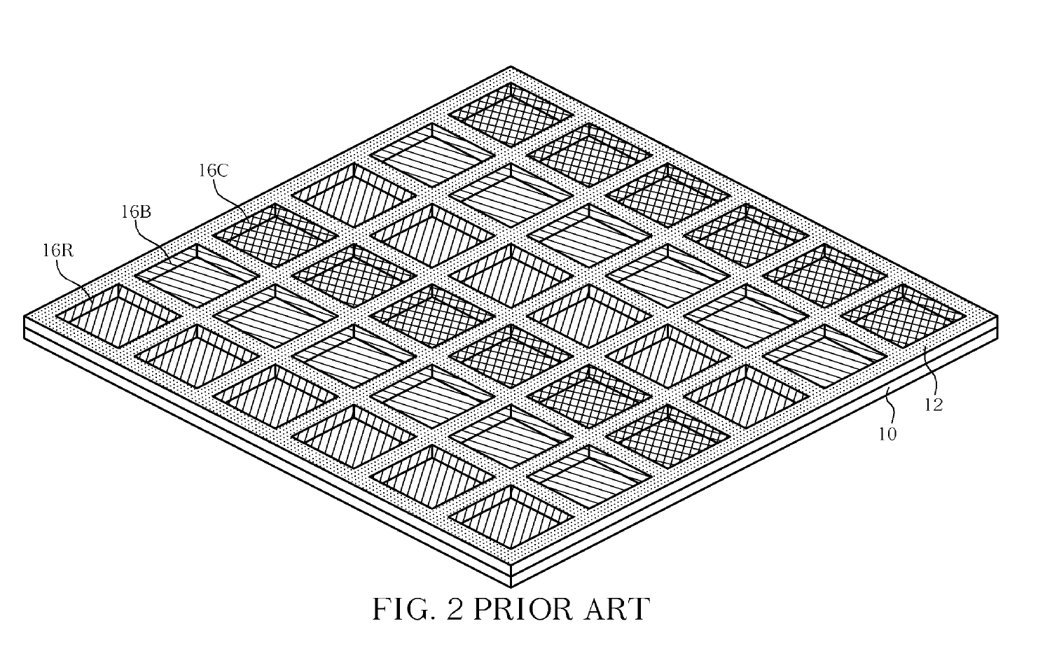

### DETAILED DESCRIPTION

Hereinafter, preferred embodiments of the present invention will be described with reference to the accompanying drawings, in which components with substantially the same functions are identified by the same reference numeral for the sake of simplicity. It should be noted, however, that the present invention is in no way limited to the following illustrative embodiments.

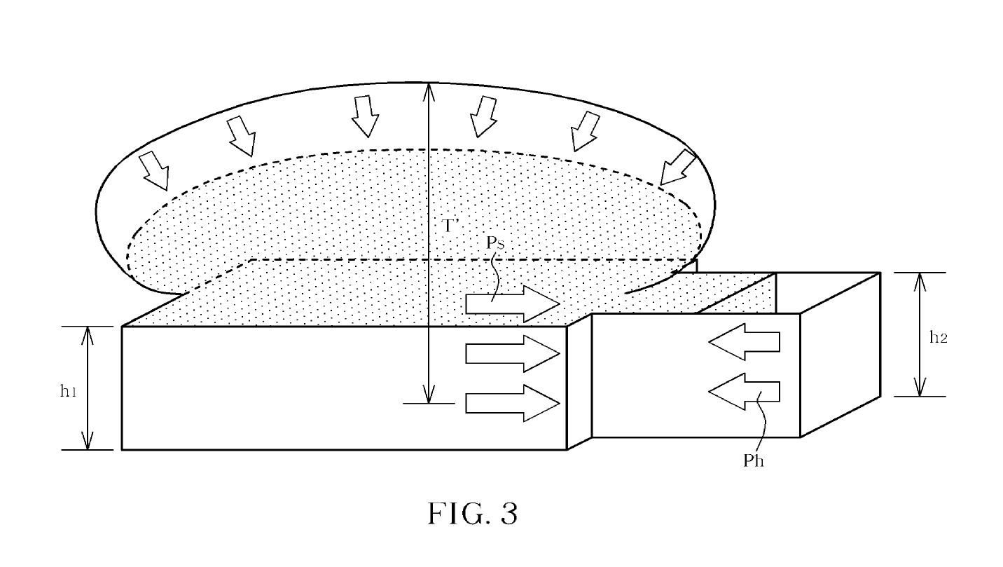

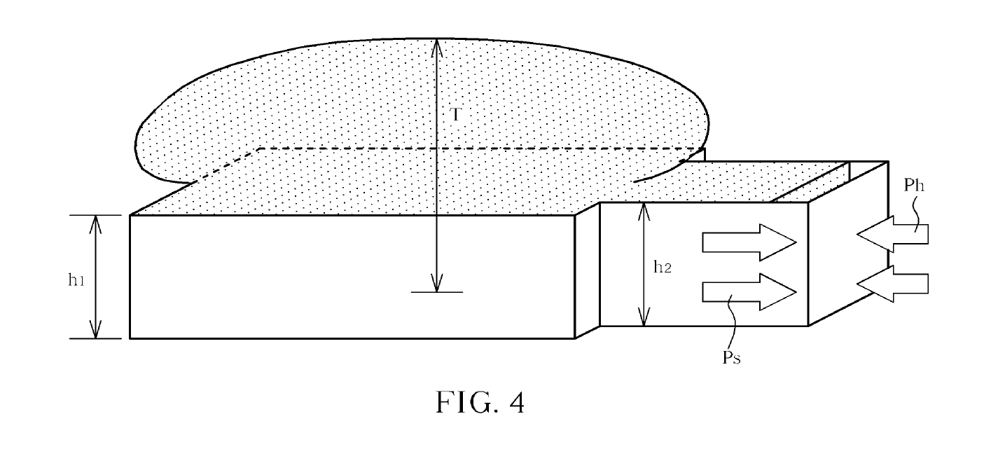

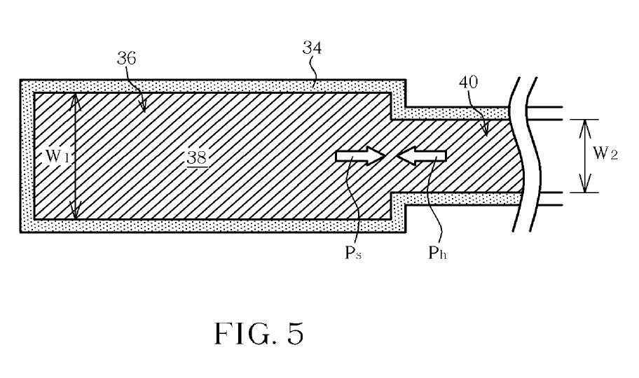

The color filter of the present invention having hydrophobic valves is capable of overcoming the problems of bad image display effect, white area, and color distortion in virtue of static balance between hydrophobic force and hydrostatic force. Please refer to FIG. 3 through FIG. 5, which are schematic diagrams illustrating the mechanism of adjusting the volume of the color filter ink in an individual space, wherein FIG. 5 shows the top view of FIG. 4. As shown in FIG. 3, a hydrostatic force, PS, resulted from the gravity of the color filter ink after the color filter ink (the precursor of color filters before drying) is injected into an individual spaces. A hydrophobic force, Pₕ, results from the hydrophobicity of the hydrophobic valve of the present invention. Theoretically, an ideal height of the color filter ink before drying is T. However, a height of the color filter ink is determined as T′, resulted from excess color filter ink. At this point, the hydrostatic force PS is greater than the hydrophobic force Pₕ, and thereby the excess color filter ink flows into the hydrophobic valve. As shown in FIG. 4 and FIG. 5, the hydrostatic force Pₛ reduces when the color filter ink flows into the hydrophobic valve, and the static balance between the hydrostatic force Pₛ and the hydrophobic force Pₕ is eventually reached.

The equations indicating the relation between the hydrostatic force Pₛ and the hydrophobic force Pₕ are shown as follows:

$$\begin{matrix}{P}_{h} = 2 \cdot {σ}_{gl} \cdot cos {θ}_{c} \cdot [ ( \frac{1}{{w}_{1}} + \frac{1}{{h}_{1}} ) - ( \frac{1}{{w}_{2}} + \frac{1}{{h}_{2}} ) ] & ( 1 ) \\ {P}_{s} = ρ \cdot g \cdot h & ( 2 )\end{matrix}$$

wherein the symbols represent:

Pₕ: hydrophobic force;

Pₛ: hydrostatic force;

σ_{gl}: surface tension of the color filter ink;

θ_{c}: contact angle between the color filter ink and the light-shielding rows;

ρ: density of the color filter ink

g: gravity index;

h: height of the color filter ink before it dried;

w₁: the width of the individual space;

h₁: the height of the individual space;

w₂: the width of the hydrophobic valve;

h₂: the height of the hydrophobic valve.

According to the equations, if the surface tension of the color filter ink, the contact angle between the color filter ink and the light-shielding rows, the density of the color filter ink, the height of the individual space, and the height of the hydrophobic valve are decided, the height of the color filter ink may be determined within a preferred range, such as T, by adjusting the width of the individual space, w₁ and the width of the hydrophobic valve, w₂, to meet a static balance between the hydrostatic force and the hydrophobic force (Pₕ=Pₛ) even though excess color filter ink is injected into the individual space. The hydrophobic valve may overcome the volume variation of the color filter ink by means of balance between the hydrophobic force and the hydrostatic force. Excess color filter ink flows into the hydrophobic valve, and therefore, the problem of color mixing resulted from overflowing of the color filter ink can be prevented. When the static balance between the hydrostatic force and the hydrophobic force is reached, the color filter ink positioned in the individual spaces is of the same height. As a result, color filters formed by a successive baking process will be of the same height, thereby improving the height consistency of the color filters.

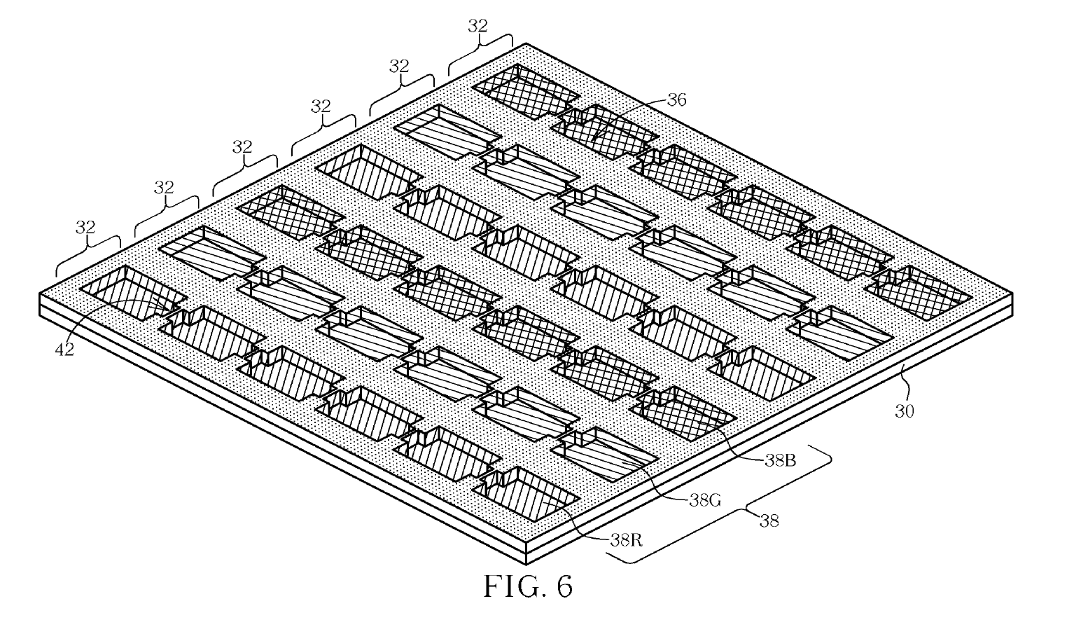

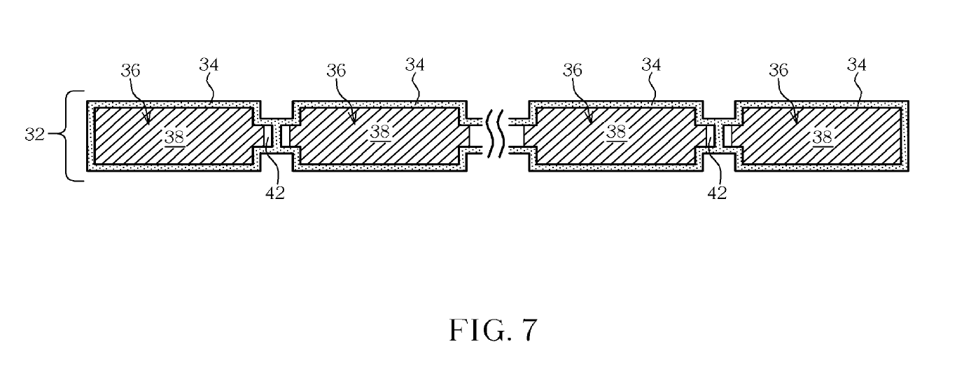

Please refer to FIG. 6 and FIG. 7, which are schematic diagrams illustrating a color filter structure according to another preferred embodiment of the present invention, wherein FIG. 6 shows an outward diagram of the color filter structure, and FIG. 7 shows a top-view diagram. As shown in FIG. 6 and FIG. 7, the color filter structure of the present invention includes a transparent substrate 30 (such as a glass substrate), a plurality of light-shielding rows 32, and a color filter layer 38. The light-shielding rows 32 are hydrophobic and are disposed on a surface of the transparent substrate 30 to define a plurality of sub-pixels. Each light-shielding row 32 includes a plurality of light-shielding structure 34 arranged in series along a first direction. Each light-shielding structure 34 has a thickness and therefore forms an individual space therein. The color filter layer 38 includes a plurality of distinct color filter patterns, such as a red color filter pattern (first color filter pattern) 38R, a green color filter pattern (second color filter pattern) 38G, and a blue color filter pattern (third color filter pattern) 38B, wherein the red color filter pattern 38R, the green color filter pattern 38G, and the blue color filter pattern 38B are alternatively disposed in stripes inside the individual spaces 36 of the light-shielding structure 32.

It should be noted that the color filter structure of the present invention has a valve that is treated by a hydrophobic treatment process to make the valve hydrophobic, and therefore is capable of providing hydrophobic force. As disclosed in the above paragraph, the print head may suffer from inevitable variation of spray coverage resulted in variable volume of the color filter ink in different individual spaces 36. Each light-shielding structure 34 of the present preferred embodiment has at least one hydrophobic indentation 42, which acts independently as a hydrophobic valve. After the color filter ink is injected into the individual space 36 and before it dries, the excess color filter ink will flow into the hydrophobic indentation 42, and thereby reduce the hydrostatic force until a static balance between the hydrophobic force and the hydrostatic force is reached. Accordingly, the color filter ink will not overflow into other individual spaces 36 of other colors in other rows. The color filter ink disposed in each individual space 36 will have the same height, and so the color filter formed by a successive baking process to dry the color filter ink will also be of the same height.

Each hydrophobic indentation 42 of the present preferred embodiment is formed on a sidewall of each light-shielding structure 34. More precisely, each hydrophobic indentation 42 is formed on the sides of the light-shielding structure 34 adjacent to another light-shielding structure 34. The individual spaces 36 disposed at two ends of the light-shielding rows 32 have a single hydrophobic indentation 42, and other individual spaces 36 have two hydrophobic indentations 42. The quantity of the hydrophobic indentation 42 is not limited to the present preferred embodiment. In addition, the hydrophobic indentations 42 do not communicate to each other, and thereby, each individual space 36 is a closed space. The hydrophobic indentation 42 is capable of providing a hydrophobic force, and thereby acts as a hydrophobic valve.

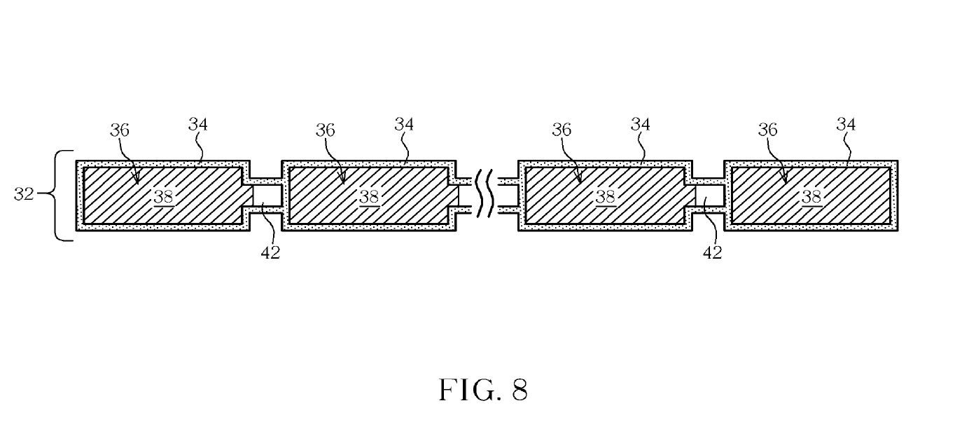

In order to emphasize the differences between the preferred embodiments, the following embodiment will be illustrated to show the difference between the preferred embodiments. Components with substantially the same functions are identified by the same reference numeral for the sake of simplicity. FIG. 8 is a top-view schematic diagram illustrating the light-shielding rows of the color filter structure according to a preferred embodiment of the present invention. The color filter structure shown in FIG. 8 is similar to the color filter structure shown in FIG. 6, but the quantity of the hydrophobic indentations 42 are modified. For example, the individual spaces 36 disposed at the ends of each light-shielding row 32 have no hydrophobic indentation 42, and other individual spaces 36 have only one hydrophobic indentation 42 thereon.

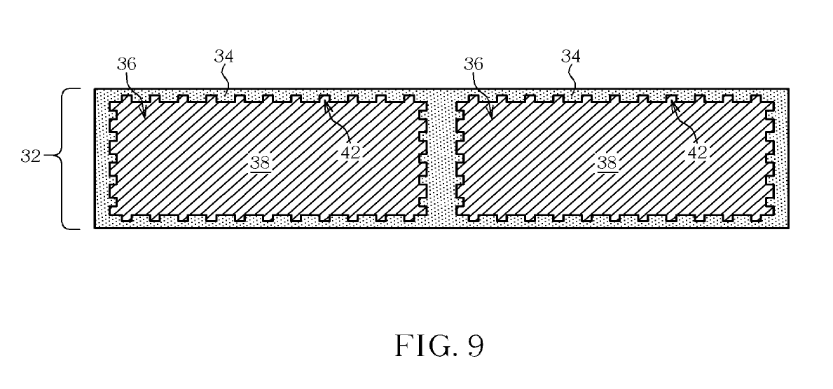

Please refer to FIG. 9, which is a top-view schematic diagram illustrating a light-shielding row of a color filter structure according to another preferred embodiment of the present invention. As can be seen in FIG. 9, each light-shielding structure 34 of the present preferred embodiment has a plurality of hydrophobic indentations 42 on the sidewall thereof compared to the single hydrophobic indention 42 shown in FIG. 6. The hydrophobic indentations 42 of each individual space 36 are disposed at a same distance from one other. It is appreciated that each individual space 36 has a first width, and the width (or the total width) of the hydrophobic indentations 42 is a second width. The ratio of the second width to the first width is substantially between 0.3 and 0.95, preferably between 0.5 and 0.9. The ratio of the second width to the first width may be modified depending on the surface tension of the color filter ink, the contact angle between the color filter ink and the light-shielding rows, and the density of the color filter ink, but is not limited to the value shown in the aforementioned preferred embodiment.

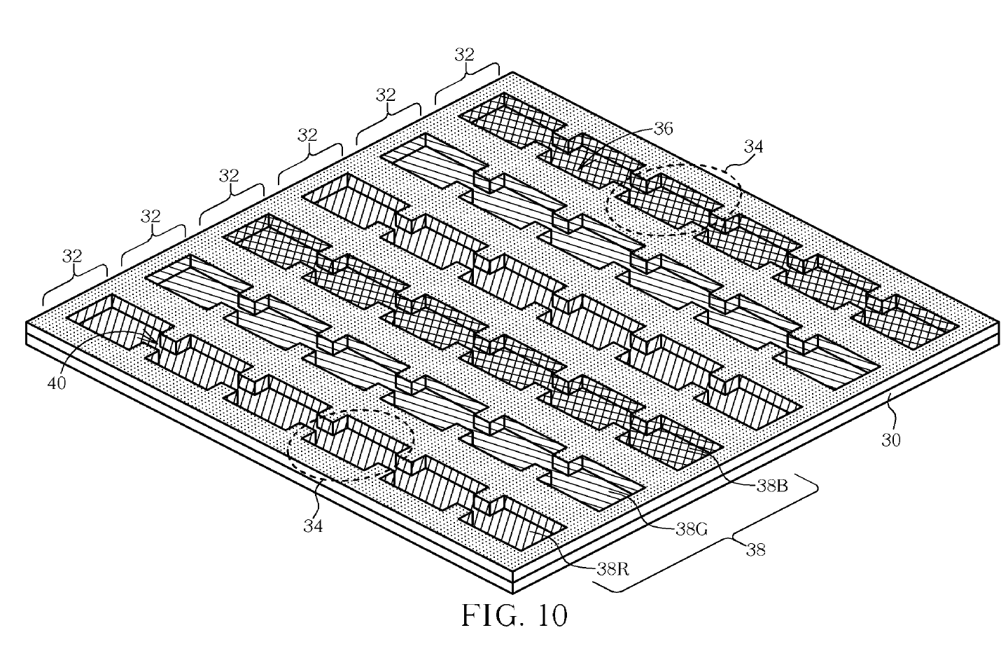

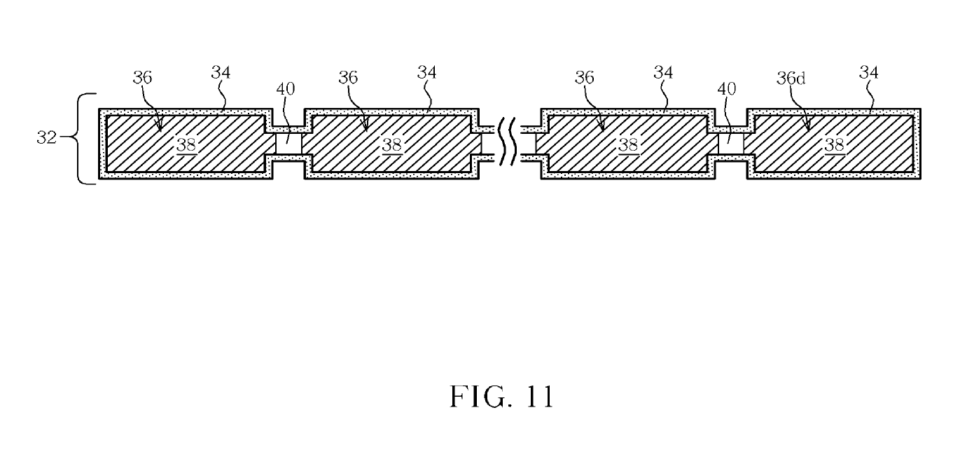

Please refer to FIG. 10 and FIG. 11, which are schematic diagrams illustrating a color filter structure according to another preferred embodiment of the present invention. FIG. 10 is an outward diagram of the color filter structure, and FIG. 11 is a top-view diagram. As shown in FIG. 10 and FIG. 11, one of the characteristics of the color filter structure of the present embodiment is that each light-shielding structure 34 has at least one hydrophobic channel 40, not including the hydrophobic indentation shown in the above-mentioned preferred embodiments. The hydrophobic channel 40 not only acts as a hydrophobic valve, but also collects the excess color filter ink flowing from other individual spaces 36 in series arranged in the same row. Therefore, the color filter ink will not overflow into other individual spaces 36 in other rows of different colors. In addition, the color filter ink in the individual spaces 36 in the same row is of the same height, and thereby the color filter layer 38 formed by a subsequent baking process has the same thickness.

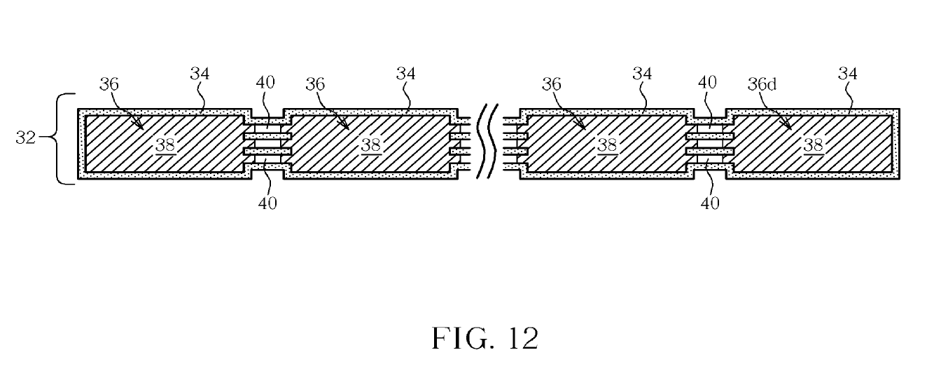

Please refer to FIG. 12, which is a top-view schematic diagram illustrating a light-shielding row of a color filter structure according to a preferred embodiment of the present invention. As shown in FIG. 12, the light-shielding structure 34 has a plurality of hydrophobic channels 40 in contrast to the light-shielding structure 34, which only has a single hydrophobic channel 40 as shown in FIG. 10.

According to the two-abovementioned embodiments, the individual space 36 has a first width, and the width (or the total width) of the hydrophobic channel 40 of each individual space is the second width. The ratio of the second width to the first width is approximately between 0.3 and 0.95, and preferably between 0.5 and 0.9. It should be noted that the second width mentioned here refers to the total width of the hydrophobic channels 40 of the individual spaces 36. Therefore, if the individual space 36 only has a single hydrophobic channel 40, the second width refers to the actual width of the hydrophobic channel 40 itself, such as the individual spaces 36 disposed at both ends of the light-shielding rows 40. If the individual space 36 has two hydrophobic channels 40, the second width refers to the total width of both hydrophobic channels 40. In addition, the ratio of the second width to the first width may be modified based on the surface tension of the color filter ink, the contact angle between the color filter ink and the light-shielding rows, and the density of the color filter ink, but is not limited to those shown in the preferred embodiment. In order to prevent light emitting leakage, the hydrophobic indentation 42 or the hydrophobic channel 40 may be positioned corresponding to the opaque structures disposed on the substrate having TFT devices thereon, such as gate lines or conductive traces of metal structures. In a high aspect ratio device, the organic dielectric layer is formed covering the gate line, so as to control the liquid crystal near the hydrophobic indentation 42 or the hydrophobic channel 40. The mechanism for preventing light emitting leakage is a well-known technique and will not be described in detail herein.

It is appreciated that the volume of the injected color filter ink is tolerable within a range, and the color filter ink inside the individual spaces 36 in the same row is affected by the hydrophobic force for preventing flow into the adjacent individual spaces 36 via the hydrophobic channel 40. However, when the volume of the injected color filter ink is in of the standard volume, the static force of the color filter ink in a certain individual space 36 is greater than the hydrophobic force resulted from the hydrophobic channel. Subsequently, the static balance is destroyed. Under this situation, the static force allows the color filter ink disposed in one individual space 36 to follow into an adjacent individual space 36 in the same row via the hydrophobic channel 40. When the volume of the color filter ink in the individual space 36 is reduced under the tolerable range, the static balance between the static force and the hydrophobic force is reached. Therefore, the color filter ink in all of the individual spaces 36 is of the same height. For the situation where a volume of the injected color filter ink is much more than the standard volume, one or several of the individual space(s) 36 of the light-shielding row 32; for instance, the individual space(s) at the end of the light-shielding row 32 may be regarded as a dummy individual space 36d shown in FIG. 11 and FIG. 12. The dummy individual space 36d may be color filter ink-free during the inkjet printing process and is capable of collecting extra color filter ink for maintaining the volume of the color filter ink within a tolerable range in other individual spaces 36.

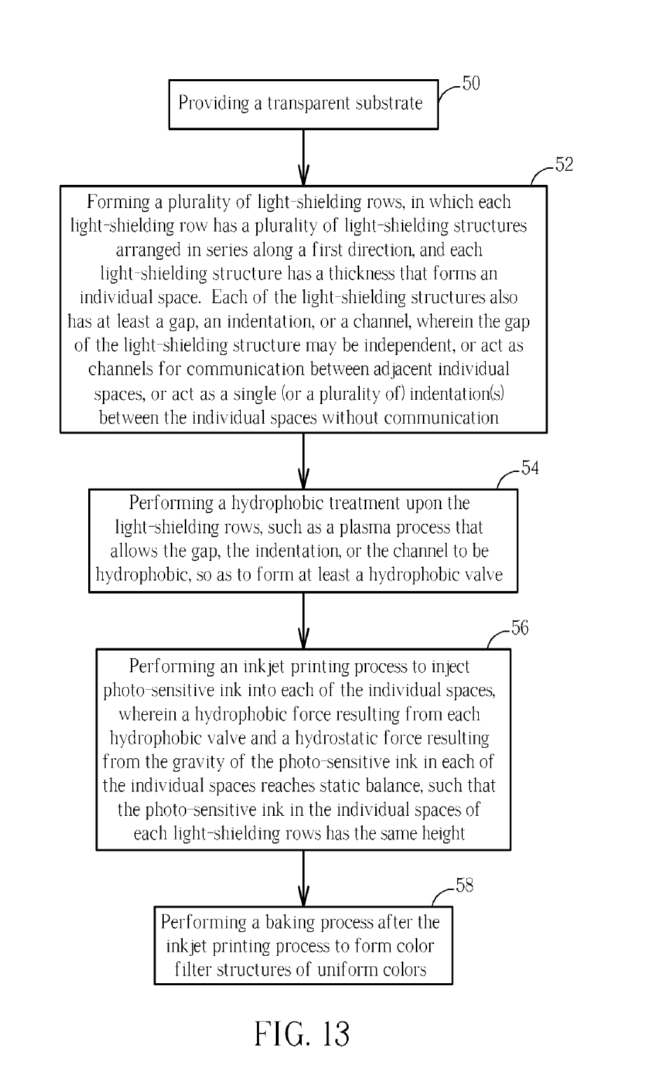

Please refer to FIG. 13 together with FIG. 6 through FIG. 12. FIG. 13 is a flow chart showing a method of making the color filter structure of the present invention. FIG. 13 shows a preferred embodiment illustrating the steps of the method of making the color filter, including:
Step 50: providing a transparent substrate;
Step 52: forming a plurality of light-shielding rows, in which each light-shielding row has a plurality of light-shielding structures arranged in series along a first direction, and each light-shielding structure has a thickness that forms an individual space. Each of the light-shielding structures also has at least a gap, an indentation, or a channel, wherein the gap of the light-shielding structure may be independent, or act as channels for communication between adjacent individual spaces, or act as a single (or a plurality of) indentation(s) between the individual spaces without communication;
Step 54: performing a hydrophobic treatment upon the light-shielding rows, such as a plasma process that allows the gap, the indentation, or the channel to be hydrophobic, so as to form at least one hydrophobic valve;
Step 56: performing an inkjet printing process to inject color filter ink into each of the individual spaces, wherein a hydrophobic force resulted from each hydrophobic valve and a hydrostatic force resulted from the gravity of the color filter ink in each of the individual spaces reaches static balance, such that the color filter ink in the individual spaces of each light-shielding rows has the same height; and
Step 58: performing a baking process after the inkjet printing process to form color filter structures of uniform colors.

According to the aforementioned embodiments, the present invention utilizes the hydrophobic valve (including the hydrophobic indentation or the hydrophobic channel) to provide a hydrophobic force. Static balance is reached by means of adjusting the width of the hydrophobic channel or the hydrophobic indentation that affects the static force resulted from the color filter ink. Therefore, the undesirable defects resulted from the variation of the inkjet printing process may be reduced, so as to improve the reliability and the yield of the color filters.

Those skilled in the art will readily observe that numerous modifications and alterations of the device and method may be made while retaining the teachings of the invention.

What is claimed is:

1. A color filter structure, comprising:
a transparent substrate having a surface;
a plurality of light-shielding rows, the light-shielding rows being hydrophobic and disposed on the surface of the transparent substrate for defining a plurality of sub-pixels, each light-shielding row comprising a plurality of light-shielding structures arranged in series along a direction, wherein each light-shielding structure with a thickness comprises an individual space and at least one hydrophobic channel, so that the adjacent individual spaces arranged in the same light-shielding row communicate with one another; and
a color filter layer disposed inside the individual spaces of the light-shielding structures.

2. The color filter structure of claim 1, wherein the light-shielding structure has a first width, the hydrophobic channel has a second width, and the ratio of the second width to the first width is substantially between 0.3 and 0.95.

3. The color filter structure of claim 2, wherein the ratio of the second width to the first width is substantially between 0.5 and 0.9.

4. The color filter structure of claim 1, wherein each light-shielding structure comprises a plurality of hydrophobic channels.

5. The color filter structure of claim 4, wherein each light-shielding structure has a first width, the width sum of the hydrophobic channels disposed in the same light-shielding structure is a second width, and the ratio of the second width to the first width is substantially between 0.3 and 0.95.

6. The color filter structure of claim 5, wherein the ratio of the second width to the first width is substantially between 0.5 and 0.9.

7. The color filter structure of claim 1, wherein the color filter layer comprises a plurality of first color filters, a plurality of second color filters, and a plurality of third color filters arranged in the individual spaces in alternate stripes.

8. The color filter structure of claim 1, wherein one of the individual spaces of each light-shielding row is a dummy space.

9. A color filter structure, comprising:
a transparent substrate having a surface;
a plurality of light-shielding rows, the light-shielding rows being hydrophobic and disposed on the surface of the transparent substrate for defining a plurality of sub-pixels, each light-shielding row comprising a plurality of light-shielding structures, wherein each light-shielding structure with a thickness comprises an individual space and at least one hydrophobic indentation, and each individual space with the hydrophobic indentation is a closed space and the adjacent individual spaces do not communicate with one another; and
a color filter layer disposed inside the individual spaces of the light-shielding structures.

10. The color filter structure of claim 9, wherein the hydrophobic indentation of each light-shielding structure and the hydrophobic indentation of the adjacent light-shielding structure are disposed on the border between the adjacent light-shielding structures.

11. The color filter structure of claim 10, wherein the light-shielding structure has a first width, the hydrophobic indentation has a second width, and the ratio of the second width to the first width is substantially between 0.3 and 0.95.

12. The color filter structure of claim 11, wherein the ratio of the second width to the first width is substantially between 0.5 and 0.9.

13. The color filter structure of claim 9, wherein each light-shielding structure comprises a plurality of hydrophobic indentations.

14. The color filter structure of claim 13, wherein each light-shielding structure has a plurality of sides, and the hydrophobic indentations are arranged on the plurality of sides of each light-shielding structure.

15. The color filter structure of claim 14, wherein each light-shielding structure has a first width, the width sum of the hydrophobic indentations disposed in the same light-shielding structure is a second width, and the ratio of the second width to the first width is substantially between 0.3 and 0.95.

16. The color filter structure of claim 15, wherein the ratio of the second width to the first width is substantially between 0.5 and 0.9.

17. A method of making a color filter structure, comprising:
providing a transparent substrate;
forming a plurality of light-shielding rows on a surface of the transparent substrate, wherein each light-shielding row comprises a plurality of light-shielding structures, each light-shielding structure with a thickness has an individual space with at least one gap;
performing a hydrophobic treatment upon the light-shielding rows to make each light-shielding structure hydrophobic and thereby to form at least one hydrophobic valve from the at least one gap; and
performing an inkjet printing process to inject color filter ink into each of the individual spaces, wherein a hydrophobic force resulted from each hydrophobic valve and a hydrostatic force resulted from the gravity of the color filter ink in each of the individual spaces reach static balance, such that the color filter ink in the individual spaces of each light-shielding rows have the same height.

18. The method of claim 17, wherein each hydrophobic valve includes a hydrophobic channel, thereby the adjacent individual spaces disposed in the same light-shielding row communicate with one another.

19. The method of claim 17, wherein each hydrophobic valve includes a hydrophobic indentation, and the hydrophobic indentations do not communicate with one another so that each individual space is a closed space.

20. The method of claim 17, wherein the hydrophobic treatment comprises a plasma process.
